(19) United States
(12) Patent Application Publication
(10) Pub. No.: US 2026/0253044 A1
(43) Pub. Date: Aug. 27, 2026

(54) DYNAMICALLY UPDATED MAINTENANCE INTERVALS

(71) Applicant: Deere & Company, Moline, IL (US)

(72) Inventors: David E. Renner, Dubuque, IA (US); Aaron R. Kenkel, Hazel Green, WI (US); Matthew J. Ramler, Luxemburg, IA (US)

(21) Appl. No.: 19/056,936

(22) Filed: Feb. 19, 2025

(51) Int. Cl. G06Q 10/20; G06F 11/34

(52) U.S. Cl. CPC G06Q 10/20; G06F 11/34

(57) ABSTRACT

An exemplary method generally involves dynamically adjusting a maintenance interval for a work machine that includes a final drive operable to cause travel of the work machine and a hydraulic system operable to control operation of a hydraulic implement. The method generally includes monitoring usage of a selected system of the work machine, wherein the selected system comprises the final drive and/or the hydraulic system. The method further includes selecting an adjustment rate based on an operating characteristic of the selected system, adjusting a maintenance parameter according to the selected adjustment rate during usage of the selected system, and generating a maintenance recommendation in response to the maintenance parameter satisfying a maintenance criterion.

### TECHNICAL FIELD

The present disclosure generally relates to determining suggested maintenance intervals for a work machine, and more particularly but not exclusively relates to dynamically updating suggested maintenance intervals for a work machine.

### BACKGROUND

Heavy machinery often requires occasional service of machine systems in order to ensure performance and longevity. Typically, service intervals on machines are completed on the basis of engine hour accumulation. There are some systems, however, where engine hours may not necessarily provide an accurate assessment of a proper service interval, and these scenarios may vary based on machine type.

The final drive on an excavator typically includes a reservoir of oil to properly lubricate one or more moving components, such as a planetary gearset. The oil in these final drives ensures component longevity by lubricating components and helping to reject heat. Over time, this oil breaks down and needs to be serviced or changed. The change interval is dependent upon the amount of use that the final drive gets on the machine, which may not necessarily correlate well with machine engine hours.

Similarly, the implement hydraulic system on an excavator typically requires service over some period of time to replace oil and/or filters that are at or nearing the end of their useful life. The implement hydraulic system on an excavator has a common change interval, but it may be advisable to accelerate that interval if the machine auxiliary hydraulic system is used periodically. This acceleration makes correlating the hydraulic system service with machine engine hours similarly challenging. For these reasons among others, there remains a need for further improvements in this technological field.

### SUMMARY

Certain embodiments of the subject application generally relate to a method of dynamically adjusting a maintenance interval for a work machine comprising a final drive operable to cause travel of the work machine and a hydraulic system operable to control operation of a hydraulic implement, the method comprising: monitoring usage of a selected system of the work machine, wherein the selected system comprises the final drive and/or the hydraulic system; selecting an adjustment rate based on an operating characteristic of the selected system; adjusting a maintenance parameter according to the selected adjustment rate during usage of the selected system; and generating a maintenance recommendation in response to the maintenance parameter satisfying a maintenance criterion.

In certain embodiments, the selected system comprises the final drive; and wherein selecting the adjustment rate comprises selecting the adjustment rate according to a displacement setting of the final drive. In certain embodiments, the selected system comprises the final drive; wherein selecting the adjustment rate comprises: selecting a first adjustment rate in response to the final drive operating with a full displacement setting; and selecting a second adjustment rate in response to the final drive operating with a partial displacement setting; and wherein the first adjustment rate is different from the second adjustment rate.

In certain embodiments, the selected system comprises the hydraulic system; wherein the hydraulic system comprises an auxiliary hydraulic system operable to control operation of an auxiliary hydraulic component removably attached to the work machine; wherein selecting the adjustment rate comprises: selecting an auxiliary hydraulic system active adjustment rate in response to activity of the auxiliary hydraulic system; and selecting an auxiliary hydraulic system inactive adjustment rate in response to inactivity of the auxiliary hydraulic system; and wherein the auxiliary hydraulic system active adjustment rate is different from the auxiliary hydraulic system inactive adjustment rate.

In certain embodiments, selecting the auxiliary hydraulic system active adjustment rate comprises: selecting a higher adjustment rate in response to the auxiliary hydraulic implement having a heavier duty load; and selecting a lower adjustment rate in response to the auxiliary hydraulic implement having a lighter duty load.

In certain embodiments, selecting the auxiliary hydraulic system active adjustment rate comprises: selecting a first adjustment rate in response to the auxiliary hydraulic implement having a first work function; and selecting a second adjustment rate in response to the auxiliary hydraulic implement having a second work function different from the first work function; and wherein the first adjustment rate is different from the second adjustment rate.

In certain embodiments, the selected system comprises the final drive; and wherein monitoring usage of the final drive comprises monitoring a displacement setting of the final drive.

In certain embodiments, monitoring usage of the selected system comprises monitoring an input device of the work machine, the input device controlling operation of the selected system.

Certain embodiments of the subject application generally relate to a method of dynamically adjusting a maintenance recommendation for a work machine comprising a final drive operable to cause travel of the work machine, the method comprising: monitoring, by a control system, an operating time of the final drive; adjusting, by the control system, a final drive maintenance parameter based on the operating time of the final drive; and generating, by the control system, a final drive maintenance recommendation in response to the final drive maintenance parameter satisfying a final drive maintenance criterion.

In certain embodiments, the work machine further comprises a final drive input device; and wherein monitoring the operating time of the final drive comprises monitoring the final drive input device to thereby determine the operating time of the final drive.

In certain embodiments, adjusting the final drive maintenance parameter comprises adjusting the final drive maintenance parameter according to an adjustment rate; and wherein the method further comprises selecting the adjustment rate based upon a displacement setting of the final drive.

In certain embodiments, adjusting the final drive maintenance parameter comprises adjusting the final drive maintenance parameter according to an adjustment rate; and wherein the method further comprises selecting the adjustment rate based upon a duty load of the final drive.

In certain embodiments, adjusting the final drive maintenance parameter comprises adjusting the final drive maintenance parameter according to an adjustment rate; wherein the method further comprises selecting the adjustment rate as a first adjustment rate when the final drive is operating with a full displacement setting; and wherein the method further comprises selecting the adjustment rate as a second adjustment rate different from the first adjustment rate when the final drive is operating with a partial displacement setting.

In certain embodiments, generating the final drive maintenance recommendation comprises displaying the final drive maintenance parameter.

Certain embodiments of the subject application relate to a method of dynamically adjusting a maintenance recommendation for a work machine comprising a primary hydraulic implement and a hydraulic system operable to control operation of the primary hydraulic implement, wherein the hydraulic system comprises an auxiliary hydraulic system operable to control operation of an auxiliary hydraulic implement, the method comprising: selecting an adjustment rate for a hydraulic system maintenance parameter based on activity of the hydraulic system, wherein selecting the adjustment rate comprises: selecting the adjustment rate as an auxiliary hydraulic system inactive adjustment rate in response to activity of the hydraulic system and inactivity of the auxiliary hydraulic system; and selecting the adjustment rate as an auxiliary hydraulic system active adjustment rate in response to activity of the auxiliary hydraulic system; wherein the auxiliary hydraulic system active adjustment rate is greater than the auxiliary hydraulic system inactive adjustment rate; adjusting the hydraulic system maintenance parameter according to the selected adjustment rate; and generating a hydraulic system maintenance recommendation in response to the hydraulic system maintenance parameter satisfying a hydraulic system maintenance criterion.

In certain embodiments, the auxiliary hydraulic implement is removably attached to the work machine; and wherein the method further comprises selecting the auxiliary hydraulic system active adjustment rate based on a characteristic of the removably attached auxiliary hydraulic implement.

In certain embodiments, selecting the auxiliary hydraulic system active adjustment rate based on a characteristic of the removably attached auxiliary hydraulic implement comprises selecting the auxiliary hydraulic system active adjustment rate based on a duty load of the removably attached auxiliary hydraulic implement.

In certain embodiments, selecting the auxiliary hydraulic system active adjustment rate based on a characteristic of the removably attached auxiliary hydraulic implement comprises: selecting the auxiliary hydraulic system active adjustment rate as a higher adjustment rate in response to the removably attached auxiliary hydraulic implement having a heavier duty load; and selecting the auxiliary hydraulic system active adjustment rate as a lower adjustment rate in response to the removably attached auxiliary hydraulic implement having a lighter duty load.

In certain embodiments, the auxiliary hydraulic system active adjustment rate is 1.1 to 4.5 times the auxiliary hydraulic system inactive adjustment rate.

In certain embodiments, selecting the adjustment rate further comprises selecting the adjustment rate as zero when the hydraulic system is inactive.

Certain embodiments of the present application relate to a method of dynamically adjusting a maintenance interval for a work machine [100] comprising a final drive [110] operable to cause travel of the work machine [100] and a hydraulic system [120] operable to control operation of a hydraulic implement [180, 190], the method comprising: monitoring [220, 320] usage of a selected system [110, 120] of the work machine [100], wherein the selected system comprises the final drive [110] and/or the hydraulic system [120]; selecting [240, 340] an adjustment rate based on an operating characteristic of the selected system [110, 120]; adjusting [250, 350] a maintenance parameter according to the selected adjustment rate during usage of the selected system [110, 120]; and generating [270,370] a maintenance recommendation in response to the maintenance parameter satisfying a maintenance criterion.

In certain embodiments, the selected system [110, 120]; comprises the final drive ; and wherein selecting the adjustment rate comprises selecting the adjustment rate according to a displacement setting of the final drive [110].

In certain embodiments, the selected system comprises the final drive ; wherein selecting the adjustment rate comprises: selecting a first adjustment rate [242] in response to the final drive [110] operating with a full displacement setting; and selecting a second adjustment rate [244] in response to the final drive [110] operating with a partial displacement setting; and wherein the first adjustment rate is different from the second adjustment rate.

In certain embodiments, the selected system comprises the hydraulic system ; wherein the hydraulic system [120] comprises an auxiliary hydraulic system [150] operable to control operation of an auxiliary hydraulic implement [190] removably attached to the work machine [100]; wherein selecting the adjustment rate comprises: selecting [340] an auxiliary hydraulic system active adjustment rate in response to activity of the auxiliary hydraulic system ; and selecting an auxiliary hydraulic system inactive adjustment rate in response to inactivity of the auxiliary hydraulic system [120]; and wherein the auxiliary hydraulic system active adjustment rate is different from the auxiliary hydraulic system inactive adjustment rate.

In certain embodiments, selecting the auxiliary hydraulic system active adjustment rate comprises: selecting [342] a higher adjustment rate in response to the auxiliary hydraulic implement [190] having a heavier duty load; and selecting [344] a lower adjustment rate in response to the auxiliary hydraulic implement [190] having a lighter duty load.

In certain embodiments, selecting the auxiliary hydraulic system active adjustment rate comprises: selecting [342] a first adjustment rate in response to the auxiliary hydraulic implement [190] having a first work function; and selecting [344] a second adjustment rate in response to the auxiliary hydraulic implement [190] having a second work function different from the first work function; and wherein the first adjustment rate is different from the second adjustment rate.

In certain embodiments, the selected system comprises the final drive ; and wherein monitoring usage of the final drive [110] comprises monitoring a displacement setting of the final drive [110].

In certain embodiments, monitoring usage of the selected system [110, 120] comprises monitoring an input device [141, 142, 145] of the work machine [100], the input device [141, 142, 145] controlling operation of the selected system [110, 120].

Certain embodiments of the present application generally relate to a method of dynamically adjusting a maintenance recommendation for a work machine [100] comprising a primary hydraulic implement [180] and a hydraulic system [120] operable to control operation of the primary hydraulic implement [180], wherein the hydraulic system [120] comprises an auxiliary hydraulic system [150] operable to control operation of an auxiliary hydraulic implement [190], the method comprising: selecting [332, 340] an adjustment rate for a hydraulic system maintenance parameter based on activity of the hydraulic system [120], wherein selecting the adjustment rate comprises: selecting [332] the adjustment rate as an auxiliary hydraulic system inactive adjustment rate in response to activity of the hydraulic system [120] and inactivity of the auxiliary hydraulic system [150]; and selecting [340] the adjustment rate as an auxiliary hydraulic system active adjustment rate in response to activity of the auxiliary hydraulic system [150]; wherein the auxiliary hydraulic system active adjustment rate is greater than the auxiliary hydraulic system inactive adjustment rate; adjusting [350] the hydraulic system hydraulic system maintenance recommendation in response to the hydraulic system maintenance parameter satisfying a hydraulic system maintenance criterion.

In certain embodiments, the auxiliary hydraulic implement [190]is removably attached to the work machine [100]; and wherein the method further comprises selecting [340] the auxiliary hydraulic system active adjustment rate based on a characteristic of the removably attached auxiliary hydraulic implement [190].

In certain embodiments, selecting [340] the auxiliary hydraulic system [120] active adjustment rate based on a characteristic of the removably attached auxiliary hydraulic implement [190] comprises selecting [340] the auxiliary hydraulic system active adjustment rate based on a duty load of the removably attached auxiliary hydraulic implement [190].

In certain embodiments, selecting [340] the auxiliary hydraulic system [120] active adjustment rate based on a characteristic of the removably attached auxiliary hydraulic implement [190] comprises: selecting [342] the auxiliary hydraulic system [120] active adjustment rate as a higher adjustment rate in response to the removably attached auxiliary hydraulic implement [180, 190] having a heavier duty load; and selecting [344] the auxiliary hydraulic system [120] active adjustment rate as a lower adjustment rate in response to the removably attached auxiliary hydraulic implement [190] having a lighter duty load.

In certain embodiments, the auxiliary hydraulic system active adjustment rate is 1.1 to 4.5 times the auxiliary hydraulic system inactive adjustment rate.

In certain embodiments, selecting the adjustment rate further comprises selecting the adjustment rate as zero when the hydraulic system is inactive.

In certain embodiments, the method further comprises determining activity of the hydraulic system based on usage of an input device [142, 145] controlling operation of the hydraulic system [120].

Further embodiments, forms, features, and aspects of the present application shall become apparent from the description and figures provided herewith.

### BRIEF DESCRIPTION OF THE FIGURES

FIG. 1 is an illustration of a work machine according to certain embodiments.

FIG. 2 is a schematic block diagram of the work machine.

FIG. 3 is a schematic flow diagram of a process according to certain embodiments.

FIG. 4 is a schematic flow diagram of a process according to certain embodiments

FIG. 5 is a schematic block diagram of a computing device that may be utilized in connection with certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to "one embodiment," "an embodiment," "an illustrative embodiment," etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a "preferred" component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of "at least one of A, B, and C" can mean (A); (B); (C); (A and B); (B and C); (A and C); or (A, B, and C). Similarly, items listed in the form of "at least one of A, B, or C" can mean (A); (B); (C); (A and B); (B and C); (A and C); or (A, B, and C). Items listed in the form of "A, B, and/or C" can also mean (A); (B); (C); (A and B); (B and C); (A and C); or (A, B, and C). Further, with respect to the claims, the use of words and phrases such as "a," "an," "at least one," and/or "at least one portion" should not be interpreted so as to be limiting to only one such element unless specifically stated to the contrary, and the use of phrases such as "at least a portion" and/or "a portion" should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

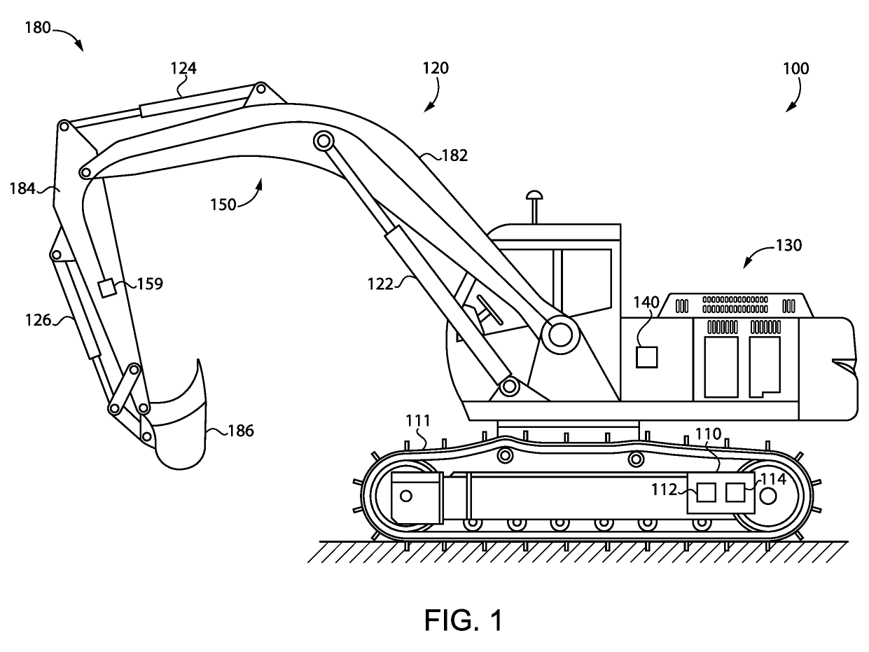

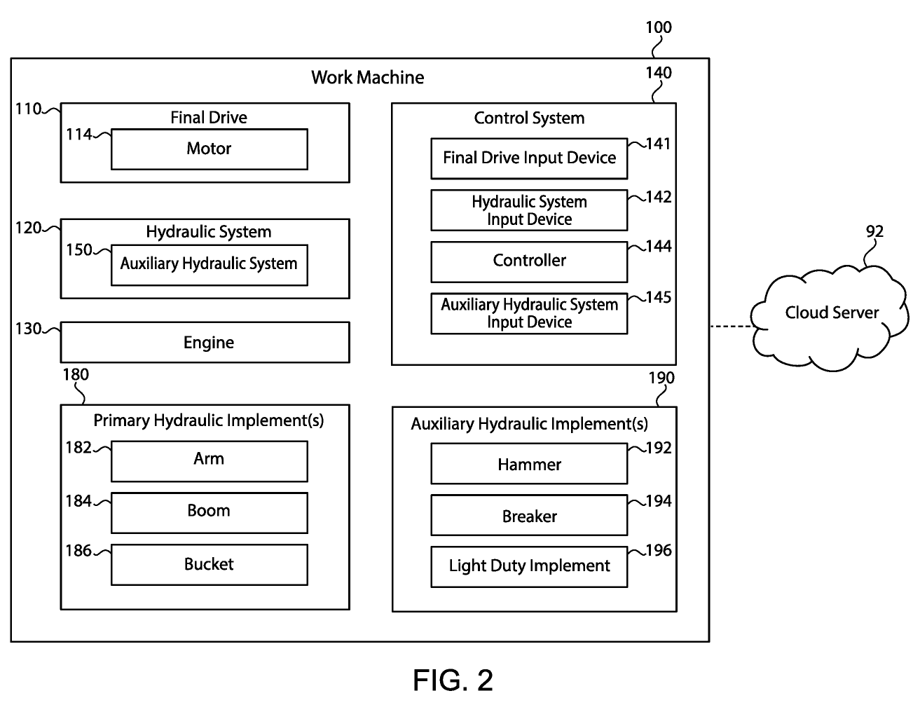

With reference to FIGS. 1 and 2, illustrated therein is a work machine 100 according to certain embodiments. While the illustrated work machine 100 is provided in the form of an excavator, it should be appreciated that the principles set forth herein may be utilized in connection with other forms of work machine, such as a crawler dozer. The work machine 100 generally includes a final drive 110 operable to move the work machine 100 along the ground (e.g., by driving a track 111), a hydraulic system 120 that facilitates performance of one or more work operations of the work machine 100, an engine 130 that provides power for the final drive 110 and/or the hydraulic system 120, and a control system 140 that controls operation of the final drive 110 and the hydraulic system 120. As described herein, the control system 140 is also configured to dynamically adjust a recommended maintenance interval for the final drive 110 and/or the hydraulic system 120 based on usage of the final drive 110 and/or usage of the hydraulic system 120.

The final drive 110 is operable to cause travel of the work machine 100 based on inputs received from the control system 140. The illustrated final drive 110 generally includes a planetary gearbox 112 and a hydraulic motor 114 operable to drive the gearbox 112. In certain forms, the motor 114 may be a two-speed fixed displacement motor operable in each of a first displacement setting (e.g., max displacement) and a second displacement setting (e.g., partial displacement). In the illustrated form, the final drive 110 can be controlled by a user onboard the work machine 100, for example via a final drive input device 141 of the control system 140. The final drive input device 141 may, for example, include one or more of a pedal, a lever, a steering wheel, a joystick, a control panel, and/or another form of interface operable by a user. It is also contemplated that the work machine 100 may be at least partially autonomous and/or remotely controlled, in which case the final drive input device 141 may not necessarily be operable by a user onboard the work machine 100. Inputs to the final drive input device 141 may be received by a controller 144 of the control system 140, which may control operation of the final drive 110 based on the inputs.

The hydraulic system 120 controls one or more primary hydraulic implements 180 of the work machine 100 based on inputs received from the control system 140. The primary hydraulic implement(s) 180 may include one or more of an arm 182, a boom 184, a bucket 186, and/or other implements, and the hydraulic system 120 may include one or more actuators operable to cause movement of the corresponding implements. For example, the illustrated hydraulic system 120 includes an arm actuator 122 for controlling movement of the arm 182, a boom actuator 124 for controlling movement of the boom 184, and a bucket actuator 126 for controlling movement of the bucket 186. The control system 140 may include one or more primary input devices 142 by which a user may cause the control system 140 to actuate the appropriate primary hydraulic implement(s) 180 by operating the hydraulic system 120.

The hydraulic system 120 includes an auxiliary hydraulic system 150 operable to control operation of an auxiliary hydraulic implement 190 that can be removably attached to the work machine 100 at an attachment point 159. For example, the auxiliary hydraulic implement 190 may include a heavy duty attachment such as a hammer 192 and/or a breaker 194. In certain forms, the auxiliary hydraulic implement 190 may include a light duty implement 196 such as a [thumb or grapple bucket. The control system 140 may include one or more auxiliary input devices 145 by which a user may cause the control system 140 to actuate the auxiliary hydraulic implement 190 by operating the auxiliary hydraulic system 150.

The control system 140 controls operation of the work machine 100, for example based on inputs received via the input devices 141, 142, 145. The control system 140 further includes a controller 144, which may be communicatively linked with the input devices 141, 142, 145 to thereby receive inputs regarding the control of the work machine 100. As will be appreciated, the controller 144 then controls operation of the work machine 100 based upon the inputs received via the input devices 141, 142, 145. In certain forms, at least a portion of the controller 144 may be provided onboard the work machine 100. Additionally or alternatively, at least a portion of the controller 144 may be positioned elsewhere, for example at a cloud server 92 that is communicatively linked with the work machine 100 via a wireless communication device of the control system 140.

As will be appreciated by those skilled in the art, the work machine 100 may require maintenance from time to time in order to ensure proper operation and promote longevity. For example, the final drive 110 and/or the hydraulic system 120 may need to undergo an oil change, filter replacement, and/or other maintenance. In certain forms, the control system 140 is configured to dynamically adjust a proposed maintenance interval for the final drive 110 based on usage of the final drive 110. In certain forms, the control system 140 is configured to dynamically adjust a proposed maintenance interval for the hydraulic system 120 based on usage of the hydraulic system 120.

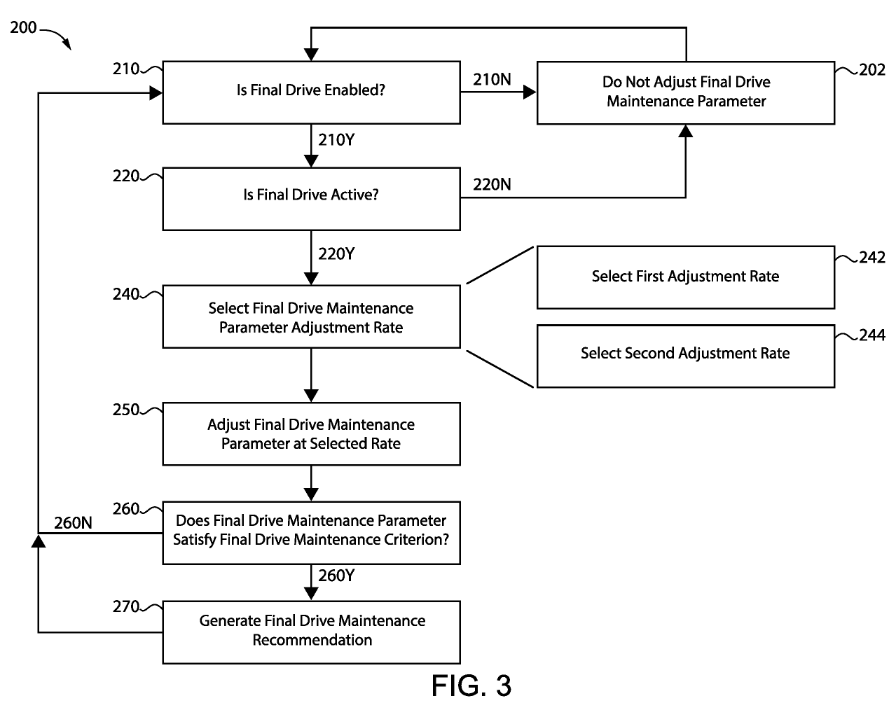

With additional reference to FIG. 3, an exemplary process 200 that may be performed using the work machine 100 is illustrated. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 200 may be performed wholly by a controller 144, whether onboard the work machine 100 or at a cloud server 92, or that the blocks may be distributed among one or more of the elements and/or additional devices or systems that are not specifically illustrated in FIGS. 1 and 2. Additionally, while the blocks are illustrated in a relatively serial fashion, it is to be understood that two or more of the blocks may be performed concurrently or in parallel with one another. Moreover, while the process 200 is described herein with specific reference to the work machine 100 illustrated in FIGS. 1 and 2, it is to be appreciated that the process 200 may be performed with work machines having additional and/or alternative features.

As described herein, the process 200 generally involves dynamically adjusting a maintenance interval for the final drive 110 based on actual usage of the final drive 110. More particularly, the process 200 generally involves dynamically adjusting a final drive maintenance parameter to thereby provide an indication of whether and/or when maintenance is recommended for the final drive 110.

In certain embodiments, the final drive maintenance parameter may correspond to a usage score that is updated based on actual usage of the final drive 110. For example, the final drive maintenance parameter may be provided in units corresponding to effective usage hours such that the maintenance parameter increases by one unit for each hour of final drive usage under standard conditions. As described herein, in certain forms, the maintenance parameter may be updated according to multipliers such that the maintenance parameter changes at different rates based on the type of usage of the final drive 110. For example, the maintenance parameter may be adjusted at a first rate in response to satisfaction of a first criterion (e.g., when the work machine 100 is operating with a first displacement setting), and may be adjusted at a second rate when the first criterion is not satisfied (e.g., when the work machine 100 is operating with a second displacement setting).

The process 200 may include block 210, which generally involves determining whether the final drive 110 is enabled. For example, block 210 may involve determining whether a hydraulic pilot is enabled, which in turn enables the final drive 110. If it is determined in block 210 that the final drive 110 is not enabled, the process 200 may continue along path 210N to block 202, in which the final drive maintenance parameter is not updated. Stated another way, because the final drive 110 is not enabled (and therefore not in use), no usage time is logged and the final drive maintenance parameter remains at its prior level. From block 202, the process 200 may return to block 210 to again determine whether the final drive 110 is enabled.

If it is determined in block 210 that the final drive 110 is enabled, the process 200 may continue along path 210Y to block 220, which generally involves determining whether the final drive 110 is in use. In certain forms, the determining of block 220 may be based on a user input to the control system 140. For example, block 220 may involve monitoring the final drive input device 141 to determine whether the final drive 110 has been commanded to activate. In certain forms, the determining of block 220 may be based on another form of input to the control system 140, which may correspond to an output of the final drive 110. For example, the determining of block 220 may involve monitoring actual travel of the work machine 100, which corresponds to activity of the final drive 110. Actual travel of the work machine 100 may be determined via the use of one or more sensors. By way of illustration, block 220 may involve determining travel of the work machine 100 based on input from a GPS sensor, a groundspeed detection device (e.g., radar or lidar), a speedometer, or another form of sensor operable to detect travel of the work machine 100. If it is determined in block 220 that the final drive 110 is enabled but inactive, the process 200 may continue along path 220N to block 202, in which the maintenance parameter is not updated, and thereafter to block 210.

If it is determined in block 220 that the final drive 110 is active, the process 200 may continue along path 220Y to an adjustment rate selection procedure 240, which generally involves selecting an adjustment rate for the final drive maintenance parameter based on one or more criteria, such as a displacement setting of the final drive 110. For example, the adjustment rate selection procedure 240 may include selectively performing one of block 242 or block 244 based on the one or more criteria. By way of illustration, if the criteria include a displacement setting of the final drive 110, the adjustment rate selection procedure 240 may involve determining a displacement setting of the final drive 110 and selecting the adjustment rate based on the determining. In such forms, block 240 may involve selecting a first adjustment rate in block 242 in response to the first displacement setting, and selecting a second adjustment rate in block 244 in response to the second displacement setting. The process 200 may continue from block 240 to block 250.

As will be appreciated, the first rate and the second rate may be different from one another. For example, in some situations, full displacement operation results in heavier duty usage of the final drive 110 than partial displacement operation, and the first rate may be greater than the second rate. In other situations, partial displacement operation may result in heavier duty usage of the final drive than full displacement operation, and the first rate may be lower than the second rate. Generally speaking, heavier-duty usage of the final drive 110 will result in more wear and tear on the final drive 110, which may dictate shorter maintenance intervals. Thus, the heavier-duty usage scenario will often involve a higher adjustment rate than the lighter-duty usage scenario.

The ratio of the available rates may vary based on one or more factors. For example, if it is determined that full displacement operation of the final drive 110 results in 50% more wear and tear than partial displacement operation, the first rate may be 1.5 times the second rate such that the final drive maintenance parameter acquires effective hours 50% faster during full displacement operation. Additionally, while the illustrated form of the adjustment rate selection procedure 240 involves selecting the adjustment rate from two available adjustment rates, it is also contemplated that the adjustment rate selection procedure 240 may involve selecting from more available adjustment rates. Regardless of whether the adjustment rate is selected from a group of available adjustment rates or on a sliding scale, the adjustment rate selection procedure 240 may be considered to involve selecting a multiplier for the adjustment rate based on one or more criteria. Moreover, in certain forms, the adjustment rate may not necessarily be dynamically selected from a plurality of adjustment rates, and may instead be a predetermined adjustment rate.

Regardless of whether the adjustment rate is selected as a predetermined rate or a dynamically determined rate, the process 200 may continue to block 250, which generally involves adjusting the final drive maintenance parameter at the selected rate. For example, if the final drive 110 is operating in the first displacement setting, block 250 may involve adjusting the maintenance parameter at the first rate. By contrast, if the final drive is operating in the second displacement setting, block 250 may involve adjusting the maintenance parameter at the second rate.

As noted above, in certain embodiments, the maintenance parameter may correspond to effective usage hours of the final drive 110. In such forms, one of the rates may cause the final drive maintenance parameter to be adjusted by one unit for each hour of operation, while another of the rates may cause the final drive maintenance parameter to be adjusted based on the usage time modified by a multiplier. For example, the maintenance parameter may be adjusted by 1 for each hour of partial displacement use, and by 1.5 for each hour of full displacement use. As noted above, the actual value for the multiplier may be selected based on the type of duty (heavier versus lighter), the wear and tear imparted to the final drive 110 as a result of such usage, and/or other criteria.

In certain embodiments, the process 200 may include block 260, which generally involves determining whether a final drive maintenance criterion is satisfied. If the final drive maintenance criterion is not satisfied, the process 200 may return along path 260N from block 260 to block 210. When the final drive maintenance criterion is satisfied, by contrast, the process 200 may continue along path 260Y to block 270, which generally involves generating a maintenance recommendation. In certain forms, block 270 may involve generating a recommendation indicating to the user that maintenance is due. Additionally or alternatively, block 270 may involve generating a recommendation indicating to the user that maintenance will be due soon.

The determining of block 260 may, for example, involve comparing the final drive maintenance parameter to a threshold value. By way of illustration, if the manufacturer recommends scheduled maintenance every 200 hours of final drive usage, block 260 may involve comparing the maintenance parameter to a threshold corresponding to a 200-hour maintenance criterion. Although this 200-hour maintenance criterion will be referenced herein for purposes of illustration, it should be appreciated that other values for the maintenance criterion are contemplated.

In certain embodiments, the process 200 may utilize a "count up" method. For example, the final drive maintenance parameter may be set to "0" after maintenance of the final drive 110 and increase according to the selected rate during usage of the final drive 110. In such forms, the final drive maintenance criterion may be considered to be satisfied when the final drive maintenance parameter exceeds a threshold value.

In certain forms, the threshold value may be a "maintenance due" threshold, and block 270 may involve generating an indication that maintenance is now due. By way of illustration, the 200-hour maintenance due criterion for the count up method may be the value "200", block 260 may involve determining that the final drive maintenance criterion is satisfied when the final drive maintenance parameter meets or exceeds the value of "200", and block 270 may involve generating a "maintenance due" recommendation in response to satisfaction of the 200-hour maintenance due criterion.

In addition or as an alternative to the maintenance due threshold, a threshold may be provided as a "maintenance upcoming" threshold, and block 270 may involve generating an indication that maintenance will be due in the near future. By way of illustration, the 200-hour maintenance upcoming criterion for the count up method may be the value "180", and block 260 may involve determining that the final drive maintenance criterion is satisfied when the final drive maintenance parameter meets or exceeds the value of "180", and block 270 may involve generating a "maintenance upcoming" recommendation in response to the satisfaction of the 200-hour maintenance upcoming criterion.

In certain embodiments, the process 200 may utilize a "count down" method. For example, the final drive maintenance parameter may be set to "200" after maintenance of the final drive 110 and decrease according to the selected rate during usage of the final drive 110. In such forms, the final drive maintenance criterion may be considered to be satisfied when the final drive maintenance parameter falls below a threshold value.

In certain forms, the threshold value may be a "maintenance due" threshold, and block 270 may involve generating an indication that maintenance is now due. By way of illustration, the 200-hour maintenance due criterion for the count down method may be the value "0", block 260 may involve determining that the final drive maintenance criterion is satisfied when the final drive maintenance parameter meets or falls below the value of "0", and block 270 may involve generating a "maintenance due" recommendation in response to the satisfaction of the 200-hour maintenance due criterion.

In addition or as an alternative to the maintenance due threshold, a threshold may be provided as a "maintenance upcoming" threshold, and block 270 may involve generating an indication that maintenance will be due in the near future. By way of illustration, the 200-hour maintenance upcoming criterion for the count down method may be the value "20", block 260 may involve determining that the final drive maintenance criterion is satisfied when the final drive maintenance parameter meets or falls below the value of "20", and block 270 may involve generating a "maintenance upcoming" recommendation in response to the satisfaction of the 200-hour maintenance upcoming criterion.

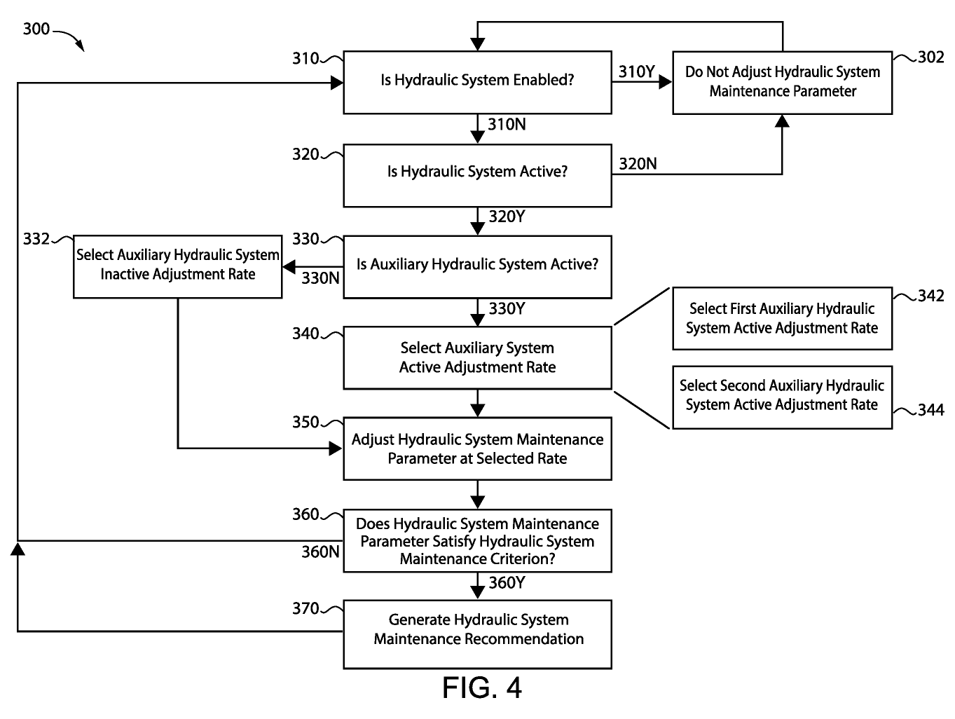

With additional reference to FIG. 4, an exemplary process 300 that may be performed using the work machine 100 is illustrated. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 200 may be performed wholly by a controller 144, whether onboard the work machine 100 or at a cloud server 92, or that the blocks may be distributed among one or more of the elements and/or additional devices or systems that are not specifically illustrated in FIGS. 1 and 2. Additionally, while the blocks are illustrated in a relatively serial fashion, it is to be understood that two or more of the blocks may be performed concurrently or in parallel with one another. Moreover, while the process 300 is described herein with specific reference to the work machine 100 illustrated in FIGS. 1 and 2, it is to be appreciated that the process 300 may be performed with work machines having additional and/or alternative features.

As described herein, the process 300 generally involves dynamically adjusting a maintenance interval for the hydraulic system 120 based on actual usage of the hydraulic system 120 generally and/or the auxiliary hydraulic system 150 specifically. More particularly, the process 300 generally involves dynamically adjusting a hydraulic system maintenance parameter to thereby provide an indication of whether and/or when maintenance is recommended for the hydraulic system 120.

In certain embodiments, the hydraulic system maintenance parameter may correspond to a usage score that is updated based on actual usage of the hydraulic system 120. For example, the hydraulic system maintenance parameter may be provided in units corresponding to effective usage hours such that the maintenance parameter increases by one unit for each hour of hydraulic system usage under standard conditions. As described herein, in certain forms, the maintenance parameter may be updated according to multipliers such that the maintenance parameter changes at different rates based on the type of usage of the hydraulic system 120. For example, the maintenance parameter may be adjusted at a first rate in response to satisfaction of a first criterion (e.g., the use of a heavy duty auxiliary hydraulic implement such as a hammer 192 or breaker 194), and may be adjusted at a second rate in response to satisfaction of a second criterion (e.g., the use of a light duty auxiliary hydraulic implement 196).

The process 300 may include block 310, which generally involves determining whether the hydraulic system 120 is enabled. For example, block 310 may involve determining whether a hydraulic pilot is enabled, which in turn enables the hydraulic system 120. If it is determined in block 310 that the hydraulic system 120 is not enabled, the process 300 may continue along path 310N to block 302, in which the hydraulic system maintenance parameter is not updated. Stated another way, because the hydraulic system 120 is not enabled (and therefore not in use), no usage time is logged and the maintenance parameter remains at its prior level. From block 302, the process 300 may return to block 310 to again determine whether the hydraulic system 120 is enabled.

If it is determined in block 310 that the hydraulic system is enabled, the process 300 may continue along path 310Y to block 320, which generally involves determining whether the hydraulic system 120 is in use. In certain forms, the determining of block 320 may be based on a user input to the control system 140. For example, block 320 may involve monitoring the hydraulic system input device 142 to determine whether the hydraulic system 120 has been commanded to activate. In certain forms, the determining of block 320 may be based on another form of input to the control system 140, which may correspond to an output of the hydraulic system 120. For example, the determining of block 320 may involve monitoring actual movement of the controlled implement(s), such as via one or more sensors on the implement(s) and/or on the hydraulic line(s) leading to the implement(s). If it is determined in block 320 that the hydraulic system 120 is enabled but inactive, the process 300 may continue along path 320N to block 302, in which the maintenance parameter is not updated, and thereafter to block 310.

If it is determined in block 320 that the hydraulic system 120 is active, the process 300 may continue along path 320Y to block 330, which generally involves determining whether the auxiliary hydraulic system 150 is in use. In certain forms, the determining of block 330 may be based on a user input to the control system 140. For example, block 330 may involve monitoring the auxiliary hydraulic system input device 145 to determine whether the auxiliary hydraulic system 150 has been commanded to activate. In certain forms, the determining of block 330 may be based on another form of input to the control system 140, which may correspond to an output of the auxiliary hydraulic system 150. For example, the determining of block 330 may involve monitoring actual movement of the controlled auxiliary implement 190, such as via one or more sensors on the implement and/or on the hydraulic line leading to the implement 190. If it is determined in block 330 that the hydraulic system 120 is active but the auxiliary hydraulic system 150 is inactive, the process 300 may continue along path 330N to block 332, which generally involves selecting an auxiliary system inactive adjustment rate. For example, the auxiliary system inactive adjustment rate may be a standard or baseline adjustment rate, such as 1. From block 332, the process 300 may continue to block 350 as described herein.

If it is determined in block 330 that the hydraulic system 120 is active, the process 300 may continue along path 330Y to an adjustment rate selection procedure 340, which generally involves selecting an adjustment rate for the hydraulic system maintenance parameter based on one or more criteria, such as an operating characteristic of the attached and active auxiliary hydraulic implement 190. For example, the adjustment rate selection procedure 340 may include selectively performing one of block 342 or block 344 based on the one or more criteria. By way of illustration, if the criteria include a duty load of the attached implement 190, the adjustment rate selection procedure 340 may involve determining a duty load of the attached implement 190 and selecting the adjustment rate based on the determining. In such forms, block 340 may involve selecting a first adjustment rate in block 342 in response to the implement 190 being a heavy duty implement (e.g., a hammer 192 or breaker 194), and selecting a second adjustment rate in block 344 in response to the implement 190 being a light duty implement 196. For example, the heavier duty first rate may be in a range of 2 to 4.5, and the second or lighter duty rate may be in a range of 1.1 to 3. The determining of block 340 may, for example, involve determining the duty load based on a work function of the attached implement, which may be provided to the control system 140 (e.g., by the user or by the implement 190 itself) when the implement 190 is attached. The process 300 may continue from block 340 to block 350.

In the illustrated form, the process 300 includes the above-described adjustment rate selection procedure 340, in which the adjustment rate is selected based on a characteristic of the attached implement 190 (e.g., work function and/or duty load). It is also contemplated that the adjustment rate may be selected based on one or more other criteria. Moreover, in certain forms, the adjustment rate may not necessarily be dynamically selected from a plurality of adjustment rates, and may instead be a predetermined auxiliary hydraulic system active adjustment rate.

Regardless of whether the adjustment rate is selected as a predetermined rate or a dynamically determined rate, the process 300 may continue to block 350, which generally involves adjusting the hydraulic system maintenance parameter at the selected rate. For example, if the attached implement 190 is a heavy duty implement, block 350 may involve adjusting the maintenance parameter at the first rate (e.g., a rate between 2 and 4.5). By contrast, if the attached implement 190 is a light duty implement, block 350 may involve adjusting the maintenance parameter at the second rate (e.g., a rate that is less than the first rate and between 1.1 and 3).

As noted above, in certain embodiments, the maintenance parameter may correspond to effective usage hours of the hydraulic system 120. In such forms, one of the rates may cause the hydraulic system maintenance parameter to be adjusted by one unit for each hour of operation, while the other of the rates may cause the hydraulic system maintenance parameter to be adjusted based on the usage time modified by a multiplier. For example, the maintenance parameter may be adjusted by 1 for each hour that the hydraulic system 120 is used while the auxiliary hydraulic system 150 remains inactive, and by a multiplier value in the range of 1.1 to 4.5 for each hour the auxiliary hydraulic system 150 is in use. For example, the multiplier value may be in the range of 1.1 to 3 when a lighter duty implement 196 is used, and may be in the range of 2 to 4.5 when a heavier duty implement 192, 194 is used. As noted above, the actual value for the multiplier may be selected based on the type of duty (heavier versus lighter) and/or the wear and tear imparted to the hydraulic system 120 as a result of such usage.

In certain embodiments, the process 300 may include block 360, which generally involves determining whether a hydraulic system maintenance criterion is satisfied. If the hydraulic system maintenance criterion is not satisfied, the process 300 may return along path 360N from block 360 to block 310. When the hydraulic system maintenance criterion is satisfied, by contrast, the process 300 may continue along path 360Y to block 370, which generally involves generating a maintenance recommendation. In certain forms, block 370 may involve generating a recommendation indicating to the user that maintenance is due. Additionally or alternatively, block 370 may involve generating a recommendation indicating to the user that maintenance will be due soon.

The determining of block 360 may, for example, involve comparing the hydraulic system maintenance parameter to a threshold value. By way of illustration, if the manufacturer recommends scheduled maintenance every 4000 hours of hydraulic system usage, block 360 may involve comparing the maintenance parameter to a threshold corresponding to a 4000-hour maintenance criterion. Although this 4000-hour maintenance criterion will be referenced herein for purposes of illustration, it should be appreciated that other values for the maintenance criterion are contemplated.

In certain embodiments, the process 300 may utilize a "count up" method. For example, the hydraulic system maintenance parameter may be set to "0" after maintenance of the hydraulic system 120 and increase according to the selected rate during usage of the hydraulic system 120. In such forms, the hydraulic system maintenance criterion may be considered to be satisfied when the hydraulic system maintenance parameter exceeds a threshold value.

In certain forms, the threshold value may be a "maintenance due" threshold, and block 370 may involve generating an indication that maintenance is now due. By way of illustration, the 4000-hour maintenance due criterion for the count up method may be the value "4000", block 360 may involve determining that the hydraulic system maintenance criterion is satisfied when the hydraulic system maintenance parameter meets or exceeds the value of "4000", and block 370 may involve generating a "maintenance due" recommendation in response to the satisfaction of the 4000-hour maintenance due criterion.

In addition or as an alternative to the maintenance due threshold, a threshold may be provided as a "maintenance upcoming" threshold, and block 370 may involve generating an indication that maintenance will be due in the near future. By way of illustration, the 4000-hour maintenance upcoming criterion for the count up method may be the value "3800", block 360 may involve determining that the hydraulic system maintenance criterion is satisfied when the hydraulic system maintenance parameter meets or exceeds the value of "3800", and block 370 may involve generating a "maintenance upcoming" recommendation in response to the satisfaction of the 4000-hour maintenance upcoming criterion.

In certain embodiments, the process 300 may utilize a "count down" method. For example, the hydraulic system maintenance parameter may be set to "4000" after maintenance of the hydraulic system 120 and decrease according to the selected rate during usage of the hydraulic system 120. In such forms, the hydraulic system maintenance criterion may be considered to be satisfied when the hydraulic system maintenance parameter falls below a threshold value.

In certain forms, the threshold value may be a "maintenance due" threshold, and block 370 may involve generating an indication that maintenance is now due for the hydraulic system 120. By way of illustration, the 4000-hour maintenance due criterion for the count down method may be the value "0", block 360 may involve determining that the hydraulic system maintenance criterion is satisfied when the hydraulic system maintenance parameter meets or falls below the value of "0", and block 370 may involve generating a "maintenance due" recommendation in response to the satisfaction of the 4000-hour maintenance due criterion.

In addition or as an alternative to the maintenance due threshold, a threshold may be provided as a "maintenance upcoming" threshold, and block 370 may involve generating an indication that maintenance will be due in the near future. By way of illustration, the 4000-hour maintenance upcoming criterion for the count down method may be the value "200", block 360 may involve determining that the hydraulic system maintenance criterion is satisfied when the hydraulic system maintenance parameter meets or falls below the value of "200", and block 370 may involve generating a "maintenance upcoming" recommendation in response to the satisfaction of the 4000-hour maintenance upcoming criterion.

As noted above, certain embodiments of the subject application involve generating a maintenance recommendation based on the satisfaction of a maintenance criterion. Such a recommendation may take any of a number of forms. In certain embodiments, the maintenance recommendation may comprise a visual recommendation. By way of example, the maintenance recommendation may involve illuminating a warning light and/or displaying an icon or message on a display. In certain embodiments, generating the recommendation may involve displaying the maintenance parameter, for example on a display of the work machine 100. Additionally or alternatively, generating a maintenance recommendation may involve generating another form of alert, such as an audible alert. In certain forms, generating the maintenance recommendation may involve generating an electronic message (e.g., an email, a text message, etc.) indicating that recommended maintenance is due or upcoming.

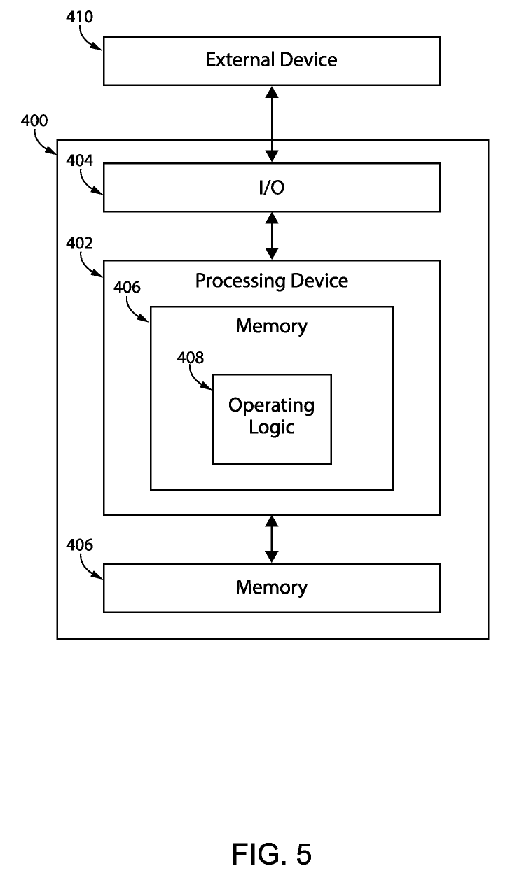

Referring now to FIG. 5, illustrated therein is a simplified block diagram of at least one embodiment of a computing device 400. The illustrative computing device 400 depicts at least one embodiment of a controller that may be utilized in connection with the controller 144 illustrated in FIG. 2.

Depending on the particular embodiment, the computing device 400 may be embodied as a server, desktop computer, laptop computer, tablet computer, notebook, netbook, Ultrabook^{TM}, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 400 includes a processing device 402 that executes algorithms and/or processes data in accordance with operating logic 408, an input/output device 404 that enables communication between the computing device 400 and one or more external devices 410, and memory 406 which stores, for example, data received from the external device 410 via the input/output device 404.

The input/output device 404 allows the computing device 400 to communicate with the external device 410. For example, the input/output device 404 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device 400. The input/output device 404 may include hardware, software, and/or firmware suitable for performing the techniques described herein.

The external device 410 may be any type of device that allows data to be inputted or outputted from the computing device 400. For example, in various embodiments, the external device 410 may be embodied as the cloud server 92, the final drive 110, the hydraulic system 120, the engine 130, the input device(s) 141, 142, 145, the primary hydraulic implement(s) 180 and/or the auxiliary hydraulic implement(s) 190. Further, in some embodiments, the external device 410 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 410 may be integrated into the computing device 400.

The processing device 402 may be embodied as any type of processor(s) capable of performing the functions described herein. In particular, the processing device 402 may be embodied as one or more single or multi-core processors, microcontrollers, or other processor or processing/controlling circuits. For example, in some embodiments, the processing device 402 may include or be embodied as an arithmetic logic unit (ALU), central processing unit (CPU), digital signal processor (DSP), and/or another suitable processor(s). The processing device 402 may be a programmable type, a dedicated hardwired state machine, or a combination thereof. Processing devices 402 with multiple processing units may utilize distributed, pipelined, and/or parallel processing in various embodiments. Further, the processing device 402 may be dedicated to performance of just the operations described herein, or may be utilized in one or more additional applications. In the illustrative embodiment, the processing device 402 is of a programmable variety that executes algorithms and/or processes data in accordance with operating logic 408 as defined by programming instructions (such as software or firmware) stored in memory 406. Additionally or alternatively, the operating logic 408 for processing device 402 may be at least partially defined by hardwired logic or other hardware. Further, the processing device 402 may include one or more components of any type suitable to process the signals received from input/output device 404 or from other components or devices and to provide desired output signals. Such components may include digital circuitry, analog circuitry, or a combination thereof.

The memory 406 may be of one or more types of non-transitory computer-readable media, such as a solid-state memory, electromagnetic memory, optical memory, or a combination thereof. Furthermore, the memory 406 may be volatile and/or nonvolatile and, in some embodiments, some or all of the memory 406 may be of a portable variety, such as a disk, tape, memory stick, cartridge, and/or other suitable portable memory. In operation, the memory 406 may store various data and software used during operation of the computing device 400 such as operating systems, applications, programs, libraries, and drivers. It should be appreciated that the memory 406 may store data that is manipulated by the operating logic 408 of processing levice 402, such as, for example, data representative of signals received from and/or sent to the input/output device 404 in addition to or in lieu of storing programming instructions defining operating logic 408. As illustrated, the memory 406 may be included with the processing device 402 and/or coupled to the processing device 402 depending on the particular embodiment. For example, in some embodiments, the processing device 402, the memory 406, and/or other :omponents of the computing device 400 may form a portion of a system-on-a-chip (SoC) and be incorporated on a single integrated circuit chip.

In some embodiments, various components of the computing device 400 (e.g., the processing device 402 and the memory 406) may be communicatively coupled via an input/output subsystem, which may be embodied as circuitry and/or components to facilitate input/output operations with the processing device 402, the memory 406, and other components of the computing device 400. For example, the input/output subsystem may be embodied as, or otherwise include, memory controller hubs, input/output control hubs, firmware devices, :ommunication links (i.e., point-to-point links, bus links, wires, cables, light guides, printed :ircuit board traces, etc.) and/or other components and subsystems to facilitate the input/output operations.

The computing device 400 may include other or additional components, such as those commonly found in a typical computing device (e.g., various input/output devices and/or other components), in other embodiments. It should be further appreciated that one or more of the components of the computing device 400 described herein may be distributed across multiple computing devices. In other words, the techniques described herein may be employed by a computing system that includes one or more computing devices. Additionally, although only a single processing device 402, I/O device 404, and memory 406 are illustratively shown in FIG. 5, it should be appreciated that a particular computing device 400 may include multiple processing devices 402, I/O devices 404, and/or memories 406 in other embodiments. Further, in some embodiments, more than one external device 410 may be in communication with the computing device 400.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as "a," "an," "at least one," or "at least one portion" are used there is no intention to limit the claim to only one item unless specifically stated to the contrary in the claim. When the language "at least a portion" and/or "a portion" is used the item can include a portion and/or the entire item unless specifically stated to the contrary.

What is claimed is:

1. A method of dynamically adjusting a maintenance interval for a work machine comprising a final drive operable to cause travel of the work machine and a hydraulic system operable to control operation of a hydraulic implement, the method comprising:
monitoring usage of a selected system of the work machine, wherein the selected system comprises the final drive and/or the hydraulic system;
selecting an adjustment rate based on an operating characteristic of the selected system;
adjusting a maintenance parameter according to the selected adjustment rate during usage of the selected system; and
generating a maintenance recommendation in response to the maintenance parameter satisfying a maintenance criterion.

2. The method of claim 1, wherein the selected system comprises the final drive; and
wherein selecting the adjustment rate comprises selecting the adjustment rate according to a displacement setting of the final drive.

3. The method of claim 2, wherein selecting the adjustment rate according to the displacement setting of the final drive comprises:
selecting a first adjustment rate in response to the final drive operating with a full displacement setting; and
selecting a second adjustment rate in response to the final drive operating with a partial displacement setting; and
wherein the first adjustment rate is different from the second adjustment rate.

4. The method of claim 1, wherein the selected system comprises the hydraulic system;
wherein the hydraulic system comprises an auxiliary hydraulic system operable to control operation of an auxiliary hydraulic component removably attached to the work machine;
wherein selecting the adjustment rate comprises:
selecting an auxiliary hydraulic system active adjustment rate in response to activity of the auxiliary hydraulic system; and
selecting an auxiliary hydraulic system inactive adjustment rate in response to inactivity of the auxiliary hydraulic system; and
wherein the auxiliary hydraulic system active adjustment rate is different from the auxiliary hydraulic system inactive adjustment rate.

5. The method of claim 4, wherein selecting the auxiliary hydraulic system active adjustment rate comprises:
selecting a higher adjustment rate in response to the auxiliary hydraulic implement having a heavier duty load; and
selecting a lower adjustment rate in response to the auxiliary hydraulic implement having a lighter duty load.

6. The method of claim 4, wherein selecting the auxiliary hydraulic system active adjustment rate comprises:
selecting a first adjustment rate in response to the auxiliary hydraulic implement having a first work function; and
selecting a second adjustment rate in response to the auxiliary hydraulic implement having a second work function different from the first work function; and
wherein the first adjustment rate is different from the second adjustment rate.

7. The method of claim 1, wherein the selected system comprises the final drive; and
wherein monitoring usage of the final drive comprises monitoring a displacement setting of the final drive.

8. The method of claim 1, wherein monitoring usage of the selected system comprises monitoring an input device of the work machine, the input device controlling operation of the selected system.

9. The method of claim 1, wherein the selected system comprises the final drive;
wherein monitoring usage of the selected system comprises monitoring, by a control system, an operating time of the final drive;
wherein adjusting the maintenance parameter comprises adjusting, by the control system, a final drive maintenance parameter based on the adjustment rate and the operating time of the final drive; and
wherein generating the maintenance recommendation comprises generating, by the control system, a final drive maintenance recommendation in response to the final drive maintenance parameter satisfying a final drive maintenance criterion.

10. The method of claim 9, wherein the work machine further comprises a final drive input device; and
wherein monitoring the operating time of the final drive comprises monitoring the final drive input device to thereby determine the operating time of the final drive.

11. The method of claim 9 wherein selecting the adjustment rate comprises selecting the adjustment rate based upon a displacement setting of the final drive.

12. The method of claim 9 wherein selecting the adjustment rate comprises selecting the adjustment rate based upon a duty load of the final drive.

13. The method of claim 11, wherein selecting the adjustment rate based upon the displacement setting of the final drive comprises:
selecting the adjustment rate as a first adjustment rate when the final drive is operating with a full displacement setting; and
selecting the adjustment rate as a second adjustment rate different from the first adjustment rate when the final drive is operating with a partial displacement setting.

14. The method of claim 9, wherein generating the final drive maintenance recommendation comprises displaying the final drive maintenance parameter.

15. The method of claim 1, wherein the selected system comprises the hydraulic system;
wherein the hydraulic system is operable to control operation of a primary hydraulic implement;
wherein the hydraulic system comprises an auxiliary hydraulic system operable to control operation of an auxiliary hydraulic implement;
wherein selecting the adjustment rate comprises:
selecting the adjustment rate as an auxiliary hydraulic system inactive adjustment rate in response to activity of the hydraulic system and inactivity of the auxiliary hydraulic system; and
selecting the adjustment rate as an auxiliary hydraulic system active adjustment rate in response to activity of the auxiliary hydraulic system;
wherein the auxiliary hydraulic system active adjustment rate is greater than the auxiliary hydraulic system inactive adjustment rate;
wherein adjusting the maintenance parameter comprises adjusting the hydraulic system maintenance parameter according to the selected adjustment rate; and
wherein generating the maintenance recommendation comprises generating a hydraulic system maintenance recommendation in response to the hydraulic system maintenance parameter satisfying a hydraulic system maintenance criterion.

16. The method of claim 15, wherein the auxiliary hydraulic implement is removably attached to the work machine; and
wherein the method further comprises selecting the auxiliary hydraulic system active adjustment rate based on a characteristic of the removably attached auxiliary hydraulic implement.

17. The method of claim 16, wherein selecting the auxiliary hydraulic system active adjustment rate based on a characteristic of the removably attached auxiliary hydraulic implement comprises selecting the auxiliary hydraulic system active adjustment rate based on a duty load of the removably attached auxiliary hydraulic implement.

18. The method of claim 16, wherein selecting the auxiliary hydraulic system active adjustment rate based on a characteristic of the removably attached auxiliary hydraulic implement comprises:
selecting the auxiliary hydraulic system active adjustment rate as a higher adjustment rate in response to the removably attached auxiliary hydraulic implement having a heavier duty load; and
selecting the auxiliary hydraulic system active adjustment rate as a lower adjustment rate in response to the removably attached auxiliary hydraulic implement having a lighter duty load.

19. The method of claim 15, wherein the auxiliary hydraulic system active adjustment rate is 1.1 to 4.5 times the auxiliary hydraulic system inactive adjustment rate.

20. The method of claim 15, wherein selecting the adjustment rate further comprises selecting the adjustment rate as zero when the hydraulic system is inactive.

21. A method of dynamically adjusting a maintenance interval for a work machine comprising a final drive operable to cause travel of the work machine, a hydraulic system operable to control operation of a hydraulic implement, the method comprising:
monitoring, by a control system, usage of the final drive;
selecting, by the control system, a final drive maintenance parameter adjustment rate based on an operating characteristic of the final drive, wherein the final drive maintenance parameter adjustment rate is selected from a plurality of different available adjustment rates;
adjusting, by the control system, a final drive maintenance parameter according to the selected final drive maintenance parameter adjustment rate during usage of the final drive according to the operating characteristic; and
generating, by the control system, a final drive maintenance recommendation in response to the final drive maintenance parameter satisfying a final drive maintenance criterion.

22. The method of claim 21, wherein generating the final drive maintenance recommendation comprises generating the final drive maintenance recommendation at the work machine.
